(19) United States
(12) Patent Application Publication
(10) Pub. No.: US 2014/0126912 A1
(43) Pub. Date: May 8, 2014

(54) SYSTEMS AND METHODS FOR INTERCONNECTION DISCOVERY IN OPTICAL COMMUNICATION SYSTEMS

(71) Applicant: CIENA CORPORATION, Hanover, MD (US)

(72) Inventor: Vipul Bhatnagar, Kensington, MD (US)

(73) Assignee: CIENA CORPORATION, Hanover, MD (US)

(21) Appl. No.: 13/670,988

(22) Filed: Nov. 7, 2012

(51) Int. Cl. H04B 10/12

(52) U.S. Cl. 398/115; 398/141; 398/142

(57) ABSTRACT

Systems and methods for automatic interconnection discovery in an optical communication system, including: a fiber optic waveguide connecting a first port to a second port, wherein the fiber optic waveguide carries a primary optical signal; and transmitting a secondary acoustic signal over the fiber optic waveguide, wherein the secondary acoustic signal is encoded with information related to one or more of the first port and the second port and/or the interconnection there between. The secondary acoustic signal is transmitted one of continuously, synchronously intermittently, and asynchronously intermittently, and does not interfere with the primary optical signal.

### FIELD OF THE INVENTION

The present invention relates generally to optical communication systems. More specifically, the present invention relates to systems and methods for interconnection discovery in optical communication systems.

### BACKGROUND OF THE INVENTION

Referring specifically to FIG. 1, an optical communication system (OCS) 10 is conventionally partitioned into multiple distinct nodes 12, each node 12 geographically separated from other nodes 12. Each node 12 consists of one or more modules 14, with each module 14 performing one or more specific operations related to inbound and/or outbound signals. Each module 14 includes one or more ports (not illustrated) and supports one or more signal interfaces (i.e., inputs and/or outputs). Correct routing of a signal through the equipment requires correct interconnections between the various modules 14 comprising the OCS 10.

OCS product manuals, engineering drawings, and detailed procedures are commonly used to define a set of correct interconnections (e.g., port 1 of module X 14 is connected to port 3 of module Y 14, etc.). If an interconnection error is made during installation, conventionally, the error would be detected either through visual audit (using the installation instructions as a reference), or through an equipment debug procedure, triggered by an observation that the OCS 10 is not working properly. This is not efficient.

The drawbacks of conventional methods for validating interconnections are that they rely on personnel-based processes (and, therefore, are susceptible to error), and require an advanced understanding of the OCS equipment (and, therefore, rely on a pool of highly trained workers). As OCS equipment becomes more complex and supports a greater number of signal interfaces, the probability of making an interconnection error increases, as does the time and skill required to locate and correct an error.

An automated solution to this problem has existed for many years—an out-of-band optical telemetry channel (OTC). The Optical Supervisory Channel (OSC) is an examplary implementation. A secondary communication channel (with the OCS signal being the primary communication channel) at an unused wavelength is wavelength-division-multiplexed onto a module's output interface, and wavelength-division-demultiplexed from a module's input interface. When an interconnection is made between arbitrary output and input ports on the modules 14 comprising an OCS 10, the module 14 with the output port signals its unique port identification to the destination port over the secondary communication channel. The module 14 with the input port receives this information and sends it to central processor (not illustrated) administering the node 12. The node's central processor aggregates all of the interconnection information from all of the modules 14 within the OCS 10 (e.g., port A on module X 14 is connected to port B on module Y 14, etc.). The node's central processor compares the auto-detected interconnections against an internally stored reference and notifies the installer of any error. Alternatively, the installer can compare the reported auto-detected interconnections against installation instructions to see if there are any errors.

Cost is a significant obstacle to the widespread usage of optical-based secondary communication channels, consisting of materials (e.g., lasers, photo-detectors, filters, power monitors, data framers, and supporting circuitry), as well as circuit board area consumption and primary signal degradation as it traverses the “overhead” associated with a secondary communication channel. For these reasons, secondary communication channels have typically been used only with “high-value” connections within an OCS 10, such as on the interconnection interfaces between nodes 12, and not on the internal connections within a node 12.

The mechanical keying of connector interfaces has also been employed for many years to avoid interconnection errors. While the mechanical keying of connector interfaces can restrict which port pairs may be interconnected, this approach is not appropriate when port pairings are circumstantially defined, rather than invariantly defined.

Clearly, improved systems and methods for avoiding interconnection errors and enabling interconnection discovery in OCSs 10 are needed.

### BRIEF SUMMARY OF THE INVENTION

In various exemplary embodiments, the present invention provides improved systems and methods for interconnection discovery in OCSs. The automatic discovery of interconnections between nodes, modules, and ports within an OCS allows the equipment to be self-aware of available equipment resources and constraints. Equipment with such knowledge can automatically adapt to accommodate new usage requests without human intervention. The present invention exploits the capability of silica optical fibers and the like to simultaneously support optical and acoustical wave propagation.

A secondary communication channel is established across two interconnected ports of an OCS. The interconnection is via an optical fiber patch cord, for example. The interconnected ports support a unidirectional “primary” signal, flowing from an origin port to a destination port. The physical interfaces at the origin and destination ports use a “physical-contact” (PC)-type of fiber optic connector. FC-PC, SC-PC, and LC-PC are industry-standard examples of PC fiber optic connectors. When two ports are interconnected by a fiber optic patch cord using PC-type connectors, an acoustic wave generated at the origin port couples to the interconnecting patch cord, and from the patch cord to the destination port.

The secondary communication channel using acoustic signaling comprises:

At the origin port:

1. An analog electrical signal generator;

2. An encoder, which embeds digital information within an analog signal generated by the electrical signal generator. Digital information includes details of the origin port, such as the host module's identification, the port number, and any other pertinent information that would be useful for the destination port to know;

3. A transducer, which generates an acoustic signal with frequency, phase, and amplitude characteristics materially proportional to the incoming electrical signal, and whose frequency is suited for propagation in a silica fiber optic waveguide; and

4. A coupling mechanism for coupling the acoustic signal to the fiber that connects to the origin port's interface without interrupting the primary signal flow.

At the destination port:

5. A decoupling mechanism, for sampling a sufficient portion of the inbound acoustic signal without interrupting the primary signal flow;

6. A transducer, which generates an electrical signal with frequency, phase, and amplitude characteristics materially proportional to the incoming acoustic signal at the decoupling mechanism's output; and

7. A decoder, which decodes the digital information embedded on the analog electrical signal at the transducer's output.

Advantages of the present invention include the following:

Electric-acoustic transducers (e.g., piezoelectric transducers) are small and inexpensive as compared to an optical-based secondary communication channel;

Acoustic signals can be non-invasively coupled to/decoupled from the fiber (e.g., with a coaxial coupling mechanism or the like), minimizing the number of in-line components the primary signal must traverse; and

The method is applicable to all wavelengths that might be used on fiber optic interconnections, whereas an optical-based secondary communication channel relies upon using an idle portion of the optical spectrum.

In one exemplary embodiment, the present invention provides a system for automatic interconnection discovery in an optical communication system, including: a fiber optic waveguide connecting an origin port to a destination port, wherein the fiber optic waveguide carries a primary optical signal; at an origin port, equipment operable for embedding a secondary acoustic signal on the fiber optic waveguide; and at a destination port, equipment operable for receiving the secondary acoustic signal embedded on the fiber optic waveguide; wherein the secondary acoustic signal is encoded with information related to the origin port. The fiber optic waveguide comprises a fiber optic patch cord. The origin port equipment includes an analog electrical signal generator operable for generating an analog electrical signal that ultimately forms the secondary acoustic signal. The origin port equipment also includes an encoder operable for digitally encoding the information related to the origin port within the analog electrical signal that ultimately forms the secondary acoustic signal. The origin port equipment further includes a transducer operable for generating the secondary acoustic signal from the encoded analog electrical signal. The origin port equipment still further includes a coupling mechanism operable for embedding the secondary acoustic signal on the fiber optic waveguide. The destination port equipment includes a decoupling mechanism operable for sampling at least a portion of the embedded secondary acoustic signal from the fiber optic waveguide without interrupting the primary signal flow. The destination port equipment also includes a transducer operable for generating an electrical signal representative of the sampled secondary acoustic signal. The destination port equipment further includes a decoder operable for decoding the information related to the origin port from the electrical signal.

In another exemplary embodiment, the present invention provides a method for automatic interconnection discovery in an optical communication system, including: providing a fiber optic waveguide connecting an origin port to a destination port, wherein the fiber optic waveguide carries a primary optical signal; at an origin port, providing equipment operable for embedding a secondary acoustic signal on the fiber optic waveguide; and at a destination port, providing equipment operable for receiving the secondary acoustic signal embedded on the fiber optic waveguide; wherein the secondary acoustic signal is encoded with information related to the origin port. The fiber optic waveguide comprises a fiber optic patch cord. The origin port equipment includes an analog electrical signal generator operable for generating an analog electrical signal that ultimately forms the secondary acoustic signal. The origin port equipment also includes an encoder operable for digitally encoding the information related to the origin port within the analog electrical signal that ultimately forms the secondary acoustic signal. The origin port equipment further includes a transducer operable for generating the secondary acoustic signal from the encoded analog electrical signal. The origin port equipment still further includes a coupling mechanism operable for embedding the secondary acoustic signal on the fiber optic waveguide. The destination port equipment includes a decoupling mechanism operable for sampling at least a portion of the embedded secondary acoustic signal from the fiber optic waveguide without interrupting the primary signal flow. The destination port equipment also includes a transducer operable for generating an electrical signal representative of the sampled secondary acoustic signal. The destination port equipment further includes a decoder operable for decoding the information related to the origin port from the electrical signal.

In a further exemplary embodiment, the present invention provides a method for automatic interconnection discovery in an optical communication system, including: providing a fiber optic waveguide connecting a first port to a second port, wherein the fiber optic waveguide carries a primary optical signal; and transmitting a secondary acoustic signal over the fiber optic waveguide, wherein the secondary acoustic signal is encoded with information related to one or more of the first port and the second port and/or the interconnection there between. The secondary acoustic signal is transmitted one of continuously, synchronously intermittently, and asynchronously intermittently, and does not interfere with the primary optical signal.

### BRIEF DESCRIPTION OF THE DRAWINGS

The present invention is illustrated and described herein with reference to the various drawings, in which like reference numbers are used to denote like system components/method steps, as appropriate, and in which:

FIG. 1 is a schematic diagram illustrating a typical OCS, including a plurality of interconnected nodes, modules, and ports, in accordance with the systems and methods of the present invention;

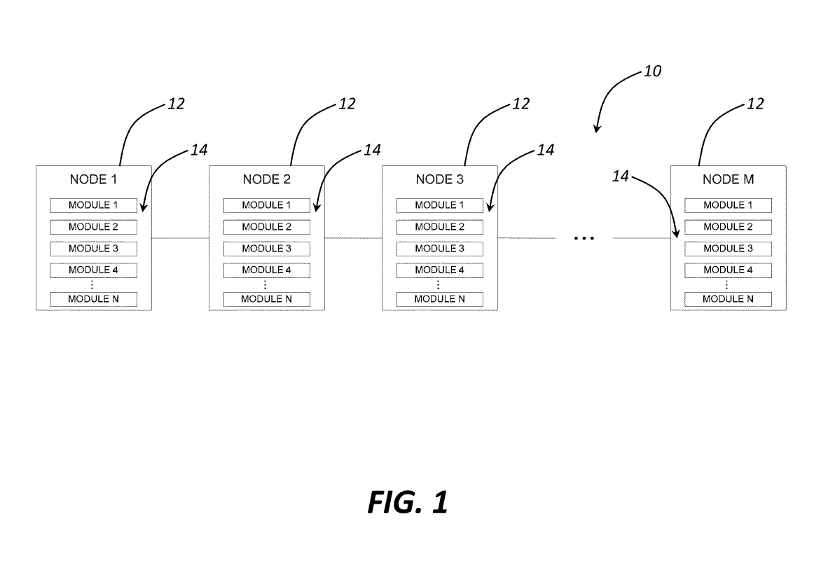

FIG. 2 is a schematic diagram illustrating one exemplary embodiment of an automated interconnection discovery system utilizing acoustical signaling over optical fiber, in accordance with the systems and methods of the present invention;

FIG. 3 is a schematic diagram illustrating one exemplary embodiment of a 2×2 directional coupler used to couple acoustic waves to an optical fiber, in accordance with the systems and methods of the present invention; and

FIG. 4 is a schematic diagram illustrating one exemplary embodiment of a piezoelectric sandwich transducer used to couple acoustic waves to an optical fiber, in accordance with the systems and methods of the present invention.

### DETAILED DESCRIPTION OF THE INVENTION

Again, in various exemplary embodiments, the present invention provides improved systems and methods for interconnection discovery in OCSs. The automatic discovery of interconnections between nodes, modules, and ports within an OCS allows the equipment to be self-aware of available equipment resources and constraints. Equipment with such knowledge can automatically adapt to accommodate new usage requests without human intervention. The present invention exploits the capability of silica optical fibers and the like to simultaneously support optical and acoustical wave propagation.

A secondary communication channel is established across two interconnected ports of an OCS. The interconnection is via an optical fiber patch cord, for example. The interconnected ports support a unidirectional “primary” signal, flowing from an origin port to a destination port. The physical interfaces at the origin and destination ports use a “physical-contact” (PC)-type of fiber optic connector. FC-PC, SC-PC, and LC-PC are industry-standard examples of PC fiber optic connectors. When two ports are interconnected by a fiber optic patch cord using PC-type connectors, an acoustic wave generated at the origin port couples to the interconnecting patch cord, and from the patch cord to the destination port.

The secondary communication channel using acoustic signaling comprises:

At the origin port:

1. An analog electrical signal generator;

2. An encoder, which embeds digital information within an analog signal generated by the electrical signal generator. Digital information includes details of the origin port, such as the host module's identification, the port number, and any other pertinent information that would be useful for the destination port to know;

3. A transducer, which generates an acoustic signal with frequency, phase, and amplitude characteristics materially proportional to the incoming electrical signal, and whose frequency is suited for propagation in a silica fiber optic waveguide; and

4. A coupling mechanism for coupling the acoustic signal to the fiber that connects to the origin port's interface without interrupting the primary signal flow.

At the destination port:

5. A decoupling mechanism, for sampling a sufficient portion of the inbound acoustic signal without interrupting the primary signal flow;

6. A transducer, which generates an electrical signal with frequency, phase, and amplitude characteristics materially proportional to the incoming acoustic signal at the decoupling mechanism's output; and

7. A decoder, which decodes the digital information embedded on the analog electrical signal at the transducer's output.

Advantages of the present invention include the following:

Electric-acoustic transducers (e.g., piezoelectric transducers) are small and inexpensive as compared to an optical-based secondary communication channel;

Acoustic signals can be non-invasively coupled to/decoupled from the fiber (e.g., with a coaxial coupling mechanism or the like), minimizing the number of in-line components the primary signal must traverse; and

The method is applicable to all wavelengths that might be used on fiber optic interconnections, whereas an optical-based secondary communication channel relies upon using an idle portion of the optical spectrum.

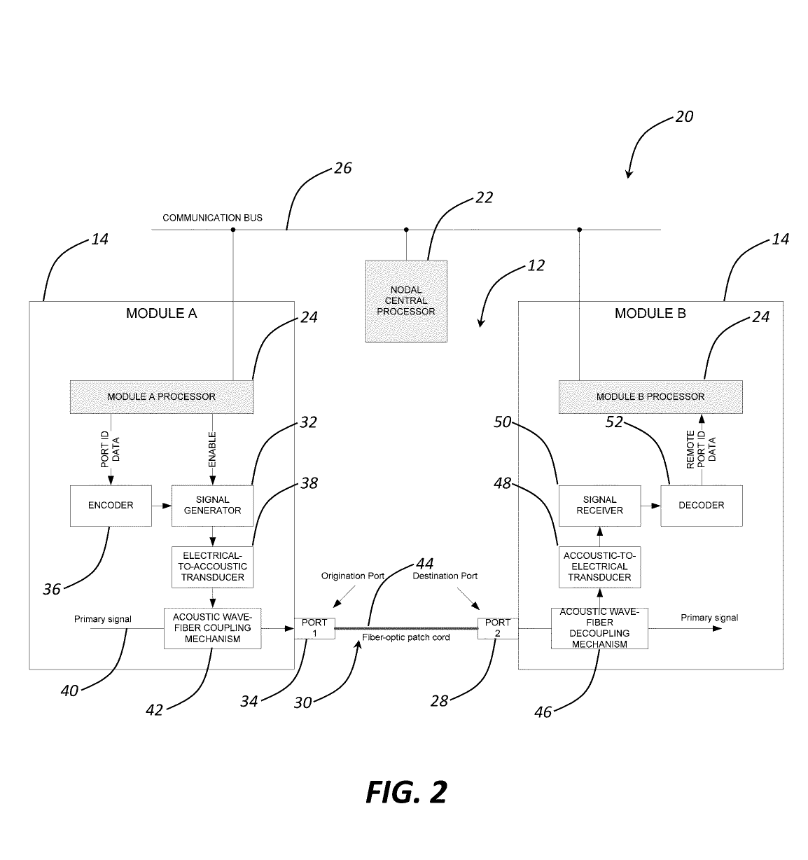

Referring specifically to FIG. 2, each node 12 within an OCS 20 is controlled by a Central Processor (CP) 22. A processor 24 associated with each module 14 is coupled to the CP 22 via a communication bus 26. When the CP 22 needs to automatically discover the destination port 28 of an interconnection 30, the CP 22 enables the signal generator 32 at the interconnection's origination port (Port 1) 34. The signal generator 32, in conjunction with an encoder 36, encodes unique identification information about the origination port 34. The encoding method (e.g., frequency modulation, phase modulation, amplitude modulation, etc.) is non-specific to the methodology. The encoded signal is applied to an electrical-to-acoustic transducer 38. The transducer 38 generates an acoustic signal, which is coupled to the fiber 40 carrying the primary signal, which terminates at the origination port (Port 1) 34. This is accomplished using an acoustic wave fiber coupling mechanism 42. A conventional method for generating an acoustic wave is using a piezoelectric crystal, which is a transducer that converts an applied electrical signal into a proportional mechanical movement (i.e., an acoustic wave). A piezoelectric crystal may also be used as an acoustic wave detector; generating an electrical signal that is proportional to an applied mechanical force.

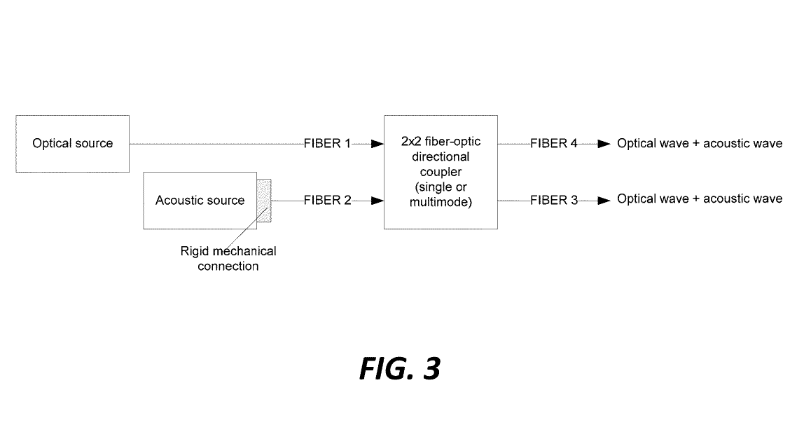

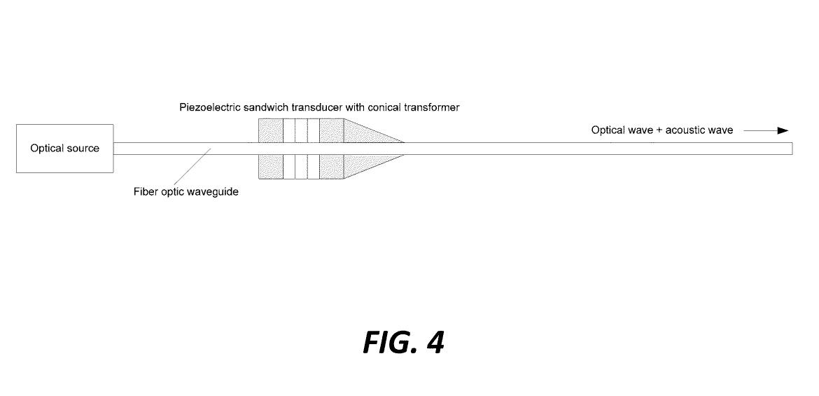

When the interconnection between Port 1 34 and Port 2 28 uses a PC-type connector, the acoustic signal couples from Port 1 34 to the interconnecting patch cord 44, and from the interconnecting patch cord 44 to Port 2 28. Acoustic waves are coupled from a source to an optical fiber through a rigid connection. This coupling arrangement may require the use of a dedicated component (such as a 2×2 directional coupler, see FIG. 3). Alternatively, a piezoelectric sandwich transducer may be used to non-invasively coaxially couple an acoustic wave to the optical fiber (see FIG. 4). Of course, techniques used to couple acoustic waves to an optical fiber may be used in reverse to decouple acoustic wave from the optical fiber, as the devices and wave coupling mechanisms are reciprocal.

An acoustic wave fiber decoupling mechanism 46 following the destination port (Port 2) 28 directs a portion of the acoustic signal to a transducer 48, which generates an electrical signal. A receiver 50 processes the incoming analog signal and recovers the digital information encoded upon it. A decoder 52 interprets the received digital information (i.e., Port 1 identification data) and the information is made available to the Module B processor 24.

In this manner, Module B 14 learns the unique port identification of the origination port (Port 1) 34 that is connected to Port 2 28.

Module B 14 may share this information with the Nodal Central Processor 22 (i.e., Module A port 1 34 is connected to Module B port 2 28). The Nodal Central Processor 22 can thus autonomously discover that an interconnection exists between Module A Port 1 34 and Module B Port 2 28. When this methodology is applied to all ports within the OCS node 12, the Nodal Central Processor 22 can autonomously discover all of the interconnected port pairs within the OCS node 12.

The following non-limiting alternatives and variations may be utilized in conjunction with the above:

Acoustic signal may propagate in a direction opposite the primary signal's direction, i.e. from destination port 28 to origin port 34;

Acoustic signaling may be either continuous, synchronously intermittent (e.g., 10 continuous seconds every hour, etc.), or asynchronously intermittent (e.g., 10 continuous seconds every time the OCS system controller initiates an interconnection discovery operation); and/or

Interconnections may be on either single mode fiber (SMF) or multimode fiber (MMF).

The present invention uses an acoustic signal to communicate information over a short length of fiber optic cable without disrupting a primary communication channel traveling over the same fiber at optical wavelengths. An exemplary acoustic frequency range is 20 kHz to 100 kHz, and an exemplary optical wavelength range is 1260 nm to 1620 nm. Heretofore, information has been sent over an optical fiber using radiation within only the optical portion of the electromagnetic spectrum.

Acoustic signal generation and detection devices, which are well known to those of ordinary skill in the art, are small and inexpensive. This approach lends itself to low cost mass manufacturing.

Auto-discovery of internal connections within an OCS are not covered by industry standards, but there are standard protocols (e.g., Neighbor Discover Protocol, etc.) used for this purpose, which rely on an underlying communication link. The acoustic signaling described in this invention would support such a protocol. Any optical networking product that has built-in adaptable functions requires a knowledge of equipment interconnections.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A system for automatic interconnection discovery in an optical communication system, comprising:
a fiber optic waveguide connecting an origin port to a destination port, wherein the fiber optic waveguide carries a primary optical signal;
at an origin port, equipment operable for embedding a secondary acoustic signal on the fiber optic waveguide; and
at a destination port, equipment operable for receiving the secondary acoustic signal embedded on the fiber optic waveguide;
wherein the secondary acoustic signal is encoded with information related to the origin port.

2. The system of claim 1, wherein the fiber optic waveguide comprises a fiber optic patch cord.

3. The system of claim 1, wherein the origin port equipment comprises an analog electrical signal generator operable for generating an analog electrical signal that ultimately forms the secondary acoustic signal.

4. The system of claim 3, wherein the origin port equipment further comprises an encoder operable for digitally encoding the information related to the origin port within the analog electrical signal that ultimately forms the secondary acoustic signal.

5. The system of claim 4, wherein the origin port equipment further comprises a transducer operable for generating the secondary acoustic signal from the encoded analog electrical signal.

6. The system of claim 5, wherein the origin port equipment further comprises a coupling mechanism operable for embedding the secondary acoustic signal on the fiber optic waveguide.

7. The system of claim 1, wherein the destination port equipment comprises a decoupling mechanism operable for sampling at least a portion of the embedded secondary acoustic signal from the fiber optic waveguide without interrupting the primary signal flow.

8. The system of claim 7, wherein the destination port equipment further comprises a transducer operable for generating an electrical signal representative of the sampled secondary acoustic signal.

9. The system of claim 8, wherein the destination port equipment further comprises a decoder operable for decoding the information related to the origin port from the electrical signal.

10. A method for automatic interconnection discovery in an optical communication system, comprising:
providing a fiber optic waveguide connecting an origin port to a destination port, wherein the fiber optic waveguide carries a primary optical signal;
at an origin port, providing equipment operable for embedding a secondary acoustic signal on the fiber optic waveguide; and
at a destination port, providing equipment operable for receiving the secondary acoustic signal embedded on the fiber optic waveguide;
wherein the secondary acoustic signal is encoded with information related to the origin port.

11. The method of claim 10, wherein the fiber optic waveguide comprises a fiber optic patch cord.

12. The method of claim 10, wherein the origin port equipment comprises an analog electrical signal generator operable for generating an analog electrical signal that ultimately forms the secondary acoustic signal.

13. The method of claim 12, wherein the origin port equipment further comprises an encoder operable for digitally encoding the information related to the origin port within the analog electrical signal that ultimately forms the secondary acoustic signal.

14. The method of claim 13, wherein the origin port equipment further comprises a transducer operable for generating the secondary acoustic signal from the encoded analog electrical signal.

15. The method of claim 14, wherein the origin port equipment further comprises a coupling mechanism operable for embedding the secondary acoustic signal on the fiber optic waveguide.

16. The method of claim 10, wherein the destination port equipment comprises a decoupling mechanism operable for sampling at least a portion of the embedded secondary acoustic signal from the fiber optic waveguide without interrupting the primary signal flow.

17. The method of claim 16, wherein the destination port equipment further comprises a transducer operable for generating an electrical signal representative of the sampled secondary acoustic signal.

18. The method of claim 17, wherein the destination port equipment further comprises a decoder operable for decoding the information related to the origin port from the electrical signal.

19. A method for automatic interconnection discovery in an optical communication system, comprising:
providing a fiber optic waveguide connecting a first port to a second port, wherein the fiber optic waveguide carries a primary optical signal; and
transmitting a secondary acoustic signal over the fiber optic waveguide, wherein the secondary acoustic signal is encoded with information related to one or more of the first port and the second port.

20. The method of claim 19, wherein the secondary acoustic signal is transmitted one of continuously, synchronously intermittently, and asynchronously intermittently.
